(19) United States
(12) Patent Application Publication
(10) Pub. No.: US 2012/0117102 A1
(43) Pub. Date: May 10, 2012

(54) QUERY SUGGESTIONS USING REPLACEMENT SUBSTITUTIONS AND AN ADVANCED QUERY SYNTAX

(75) Inventors: Dmitriy Meyerzon, Bellevue, WA (US); Victor Poznanski, Sammamish, WA (US)

(73) Assignee: MICROSOFT CORPORATION, REDMOND, WA (US)

(21) Appl. No.: 12/939,958

(22) Filed: Nov. 4, 2010

(51) Int. Cl. G06F 17/30

(52) U.S. Cl. 707/767; 707/765; 707/E17.074

(57) ABSTRACT

Query suggestion and other features are provided that include using an advanced query syntax, but are not so limited. A computer-implemented query service of an embodiment, operates to provide advanced query translations and suggestions based in part on a query rewriting algorithm that uses mappings and an advanced query syntax. A query method of one embodiment operates to provide one or more advanced queries that include one or more replacement queries that contain advanced query syntax. The method of an embodiment can automatically execute a rewritten query and/or present the rewritten query to the user as a query suggestion. Other embodiments are also disclosed.

### BACKGROUND

Computing and networking advancements have enabled the continued success of search applications to locate pertinent information for a searching user. Search engines enable users with a tool that can be used to locate relevant information. For example, a search engine can be used to locate documents, web sites, and other files using keywords. The keywords can be used by the search engine to return information that may or may not be relevant to a user's intended search result. For example, some search applications provide easily understood query suggestions for a searching user by displaying suggestions with additional directives, such as: “related searches”, “searches related to”, “did you mean to search for”, “explore related concepts”, and “show just the results for” to name a few. The prior art fails, however, to distinguish between key words that indicate the contents of the desired result and keywords that attempt to limit or modify the search in a particular manner.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide query suggestion and other features that include using an advanced query syntax, but are not so limited. In an embodiment, a computer-implemented query service operates to provide advanced query translations and suggestions based in part on a query rewriting algorithm that uses mappings and an advanced query syntax, but is not so limited. A query method of one embodiment operates to provide one or more advanced queries that include one or more replacement queries that contain an advanced query syntax. The method of an embodiment can automatically execute a rewritten query and/or present the rewritten query to the user as a query suggestion. Other embodiments are also disclosed.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing system.

FIG. 2 is a flow diagram illustrating an exemplary process of providing advanced query features.

FIG. 3 is a flow diagram illustrating an exemplary process of providing advanced query features.

FIG. 4 depicts an exemplary search interface.

FIG. 5 is a block diagram illustrating an exemplary computing environment for implementation of various embodiments described herein.

### DETAILED DESCRIPTION

Embodiments provide query suggestion and other features that include using an advanced query syntax, but are not so limited. In an embodiment, components of a system operate to provide advanced query syntax features including functionality to rewrite user queries using an advanced syntax. For example, the system of one embodiment can include a substitution dictionary that includes specific types of substitutions useful for searching in an enterprise-type setting. In one embodiment, a system includes a query rewriting component that uses a query rewriting algorithm and query rewriting features that include the use of substitution mappings between one or more recognized query inputs and one or more replacement substitutes as part of rewriting or reformulating queries. As described below, the query rewriting features can be used to replace one or more recognized query inputs with one or more rewritten or replacement queries that take advantage of advanced query syntax. Rewritten queries can be either automatically executed and the results returned to the user, or the original query can be submitted and the rewritten query can be suggested to the user as an alternate search.

In one embodiment, a computer-implemented method operates to provide advanced queries based in part on a tokenized input string. An input query provided as part of a searching operation as provided by a user often contains a number of keywords or query inputs. For example, if a user were searching for information on a new mobile phone that runs the Windows Mobile Phone 7 operating system on the Microsoft.com website, the user might type “Microsoft.com Windows Mobile Phone 7” into a search engine such as Microsoft's Bing search service available at www.bing.com. The string “Microsoft.com Windows Mobile Phone 7” is the query in this example.

An advanced query syntax can be described as a syntax that adds context to keywords that alters the interpretation of the keyword. In the above example, the term “Microsoft.com” is intended to restrict the search to the website Microsoft.com. On traditional search engines, however, without an advanced query syntax, this term would be interpreted as a keyword describing the content, and only content that mentioned the keyword “Microsoft.com” would be returned, regardless of its location on the internet. An advanced query syntax can be used to describe the intent of the term “Microsoft.com” in the users search. For example the Bing search service uses the syntax “site:” to restrict a search to a particular site. The above query could be rewritten as “site:Microsoft.com Windows Mobile 7 Phone” and the search engine would correctly restrict the search to the Microsoft.com website. See http://onlinehelp.microsoft.com/en-us/bing/ff808421.aspx for details on the Bing search syntax.

In one embodiment, if a computing method recognizes that a token of a tokenized query input matches or corresponds with any of a number of substitution items, one or more terms of the query input can be replaced by one or more advanced query syntax substitutes, and a resulting new query can be returned as part of providing advanced query suggestions. In various embodiments, a list of substitutions can be configured separately for each query language, using command line and scripting language features for example. Additionally, each list of substitutions and corresponding replacement mappings are extensible and further modifiable. For example, an administrator can augment a substitution list based on an analysis of query logs, user feedback, intuition, etc. while deleting unnecessary substitutions.

In one embodiment, when a user types in the query “Microsoft.com Windows Mobile Phone 7”, components operate to identify keywords that indicate a user intention other than a standard keyword search. In one particular embodiment, textual matching technology, such as regular expressions for example, can be used to search for particular tokens in an input query. For example, the regular expression “*.com” would match the input token “Microsoft.com”. In this embodiment, the regular expression “*.com” would be matched in a data structure, such as a look-up table for example, with an inferred user intent to search the web site “Microsoft.com” and matched to the advanced query syntax “site:”. The query would be automatically rewritten to include the advanced query syntax “site:Microsoft.com”. Alternatively, the rewritten query could be presented to a user as a suggested refinement to an existing search and run only if the user clicked a link or otherwise affirmatively selects to use the rewritten query.

Although in the previous example the advanced query syntax incorporates the original token, “Microsoft.com”, that need not be the case. For instance, if a user searched for “Quarterly Sales Slide Deck”, the literal string “Slide Deck” could be used to infer that a user wants to find files that are Microsoft PowerPoint slide decks and the query could be rewritten “Quarterly Sales filetype:ppt filetype:pptx”. In this example, the term “Slide Deck” is matched in a data structure to two replacements, “filetype:ppt” and “filetype:pptx” which limits the search to two different types of slide deck files. It should also be noted that the original term “Slide Deck” has been removed from the rewritten query because the user does not intend to look for content that contains the string “Slide Deck” so the term is not preserved in the rewritten query. It should be noted that other textual matching technology besides regular expressions can accomplish the same goal, such as literal string matching or natural language parsing.

In one embodiment, query rewriting features include replacement mappings that include a first replacement mapping from a document-related search term to one or more advanced syntax document mappings, a second replacement mapping from a spreadsheet-related search term to one or more advanced syntax spreadsheet mappings, a third replacement mapping from a drawing-related search term to one or more advanced syntax drawing mappings, a fourth replacement mapping from a presentation related search term to one or more advanced syntax presentation mappings, and a fifth replacement mapping from a site-related search term to one or more advanced syntax site mappings.

In an embodiment, a system includes a searching interface that can be included as part of a computer-readable storage medium. The searching interface can be used to provide advanced queries including using an advanced query syntax based in part on a query input. For example, a user can input keywords into a browser-based search application and a query suggestion component of the search application can operate to provide advanced queries and/or query suggestions including replacement substitutes encoded using an advanced query syntax.

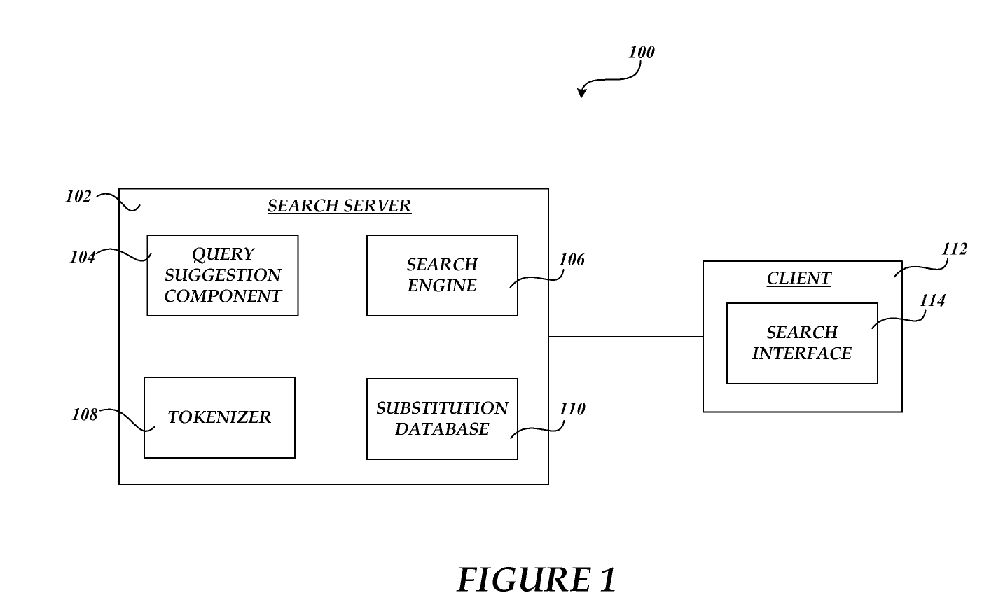

FIG. 1 is a block diagram of an exemplary system 100 that includes processing, memory, and other components that provide advanced query rewrites as part of a searching operation. As shown in FIG. 1, the system 100 includes a search server 102 that includes a query suggestion component 104, a search engine 106, a tokenizer 108, and/or a substitution store 110, but is not so limited. In addition to features described below, the functionality of the server 102 can include web content management, enterprise content services, enterprise search, shared business processes, business intelligence services, and/or other features.

The system 100 also includes at least one client 112. As one example, the system 100 can include searching and indexing features that, in addition to identifying relevant material, such as file locations, files, and/or other relevant results as examples, operates to provide advanced query rewrites including using an advanced query syntax. The advanced query syntax can be used in part to focus a searching operation by encoding search terms with the advanced query syntax which the search engine 106 can use to provide relevant search results. In one embodiment, the search engine 106 can include the functionality of the query suggestion component 104 and/or tokenizer 108. Moreover, various functionalities can be combined and further subdivided based in part on a particular client server implementation.

As shown, client 112 includes a search interface 114 that can be used in part to submit queries to search server 102. As discussed below, the query suggestion component 104 can provide advanced query suggestions encoded with the advanced query syntax to a searching user based in part on recognized input query terms. For example, the query suggestion component 104 can provide a number of selectable advanced query suggestions to the client 112 which can be automatically searched on, or be displayed adjacent to a search interface currently being used by a searching user.

In one embodiment, components of the system 100 can be used to search one or more indexed data structures as part of searching for relevant information associated with a user query. It will be appreciated that the search server 102 uses one or more search indexes, such as inverted and other index data structures for example, that map keywords to advanced query syntax. As described below, as part of a searching operation, the query suggestion component 104 can operate to provide advanced query suggestions that include replacement substitutes that include name value pairs that provide further focus to a query input. For example, components of the system 100 can be configured to provide web-based searching features that include automatically providing advanced queries including advanced query suggestions based in part on tokenized string inputs of one or more keywords, phrases, and other search items and one or more corresponding replacement substitutions.

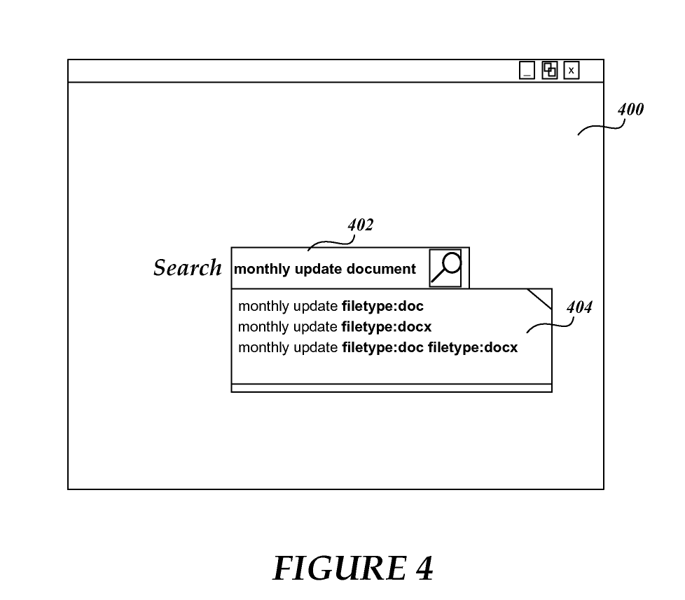

As one example, a user interface, such as a browser or search window for example, can be used to receive typed, inked, stylus, verbal, and/or other affirmative user inputs and the query suggestion component 104 can operate to provide potential replacement substitutions as a user inputs query information. A rewritten query can be automatically executed, or a user can opt to select an advanced query suggestion that includes the advanced query syntax which can be used by the search engine 106 to focus the user search based on the replacement substitutions and the advanced query syntax. In one embodiment, the query suggestion component 104 operates to provide one or more advanced query suggestions to a querying user in real time as a part of an additional window (see FIG. 4).

As shown in FIG. 1, the system 100 includes a search engine 106 configured to return search results based in part on a query input. As discussed above, the query suggestion component 104 can provide one or more advanced query suggestions, that when selected by a user, can be used by the search engine 106 to provide search results to a querying user. The query suggestion component 104 and/or search engine 106 can use tokenized input terms provided by the tokenizer 108 as part of a query rewriting and/or searching operation. For example, a user can use a computer-implemented search interface to input words, portions of words, acronyms, phrases, etc. which can be parsed and used in part to locate relevant search results, such as files, links, documents, etc.

The search engine 106 can use any number of relevancy algorithms as part of returning search results to a querying user, such as using most popular algorithms, most recent algorithms, and other features to return search results including links (e.g., uniform resource locaters (URLs)) to files, documents, web pages, file content, virtual content, web-based content, and/or other information. For example, the search engine 106 can use text, property information, and/or metadata when returning relevant search results associated with local files, remotely networked files, combinations of local and remote files, etc.

The search engine 106 of one embodiment uses indexed and other information to return search results using a ranking and/or relevancy algorithm and one or more advanced query rewrites. In an embodiment, as part of a search, the search engine 106 can use one or more selected advanced query suggestions and operate to return a set of candidate results, such as a number of ranked links to candidate files or sites for example that correspond with the focus provided by the encoded advanced query syntax portions of a particular advanced query suggestion. For example, query terms encoded with advanced query syntax can be used to focus a search to specific file types and/or locations, including any associated searchable metadata.

Accordingly, the search engine 106 can use the advanced query syntax to provide searchers and site owners with functionality to obtain more productive searches and/or exploration of advanced query terms and concepts. As a user interacts with suggestions and search results, the user learns and becomes more familiar with the advanced syntax. Correspondingly, a user will be able to enter advanced query syntax query terms directly as part of a searching operation. Another advantage enables educating and teaching users how to use the advanced query syntax so that users can input more exact searches using the advanced query syntax.

With continuing reference to FIG. 1, in one embodiment, the query suggestion component 104 can use a query suggestion algorithm and a number of replacement substitutes (see examples in Table below) to provide advanced query suggestions that include advanced query syntax. For example, after using a search algorithm to locate popular queries associated with a user's current input, the query suggestion component 104 can use a query suggestion algorithm to provide one or more advanced query suggestions that include a number of replacement substitutes encoded with advanced query syntax along with one or more of the original tokens. The substitution algorithm can substitute an entire string for a token in the query, such as replacing “slide deck” with “filetype:ppt”, or it can re-use all or a portion of the original token, such as replacing “Microsoft.com” with “site:Microsoft.com”, or replacing “www.microsoft.com” with “site:Microsoft.com”.

The query suggestion component 104 can also operate to replace an original token with a replacement substitute that includes an advanced query syntax encoding when an original token maps to any item identified as a replaceable item as defined in part by the substitution database 110. The query suggestion component 104 of one embodiment operates to automatically replace a matched original token with a corresponding replacement substitute. For example, the query suggestion component 104 can operate to provide an advanced query suggestion by first replacing an original token (e.g., a word, acronym, etc.) with one or more substitution targets encoded with the advanced query syntax. The resulting new query can be returned to the client and presented to a user as part of query suggestion results.

In one embodiment, the substitution database 110 includes a dictionary of substitutions including mappings from recognized query terms to one or more replacement substitutions. The table below provides a number of exemplary substitution mappings between a number of query terms or original tokens and a number of replacement substitutes. The dictionary can be further modified to include additional mappings (and fewer) and comports with an extensible data structure. In the table below, where multiple mappings can be made, each individual mapping is separated with a semicolon, so for instance “doc” or document can be replaced with “filetype:doc” to search for files ending in .doc, or “filetype:docx” to search for files ending in .docx or “filetype:doc filetype:docx” to search for files ending in either .doc or docx.

TABLE

| Recognized query term | |
|---|---|
| (input list case insensitive) | Replacement substitutions |
| Doc; docx; document | filetype: doc; filetype: docx |
| Ppt; pptx; presentation; slide; slide deck | filetype: ppt; filetype: pptx |
| Xls; xlsx; spreadsheet; sheet | filetype: xsl; filetype: xlsx |
| site | contentclass: sts_site |
| *.com; *.edu; *.gov | site: {original token} |
| English; French; German | Language: {original token} |
| other input items | Extensible |
| | property type(s): value(s) |

In certain cases, the search server 102 can operate to provide advanced query suggestions with or without replacement substitutions including an advanced query syntax. As shown, replacement substitutions filetype:doc or filetype:docx provide further focus by limiting search results to file types that include the .doc or .docx file extensions. The replacement substitutions filetype:ppt or filetype:pptx provide further focus by limiting search results to file types that include the “ppt” or “pptx” file extensions. The replacement substitutions filetype:xsl or filetype:xslx provide further focus by limiting search results to file types that include the “xls” or “xlsx” file extensions. The replacement substitution contentclass:sts_site provides further focus by limiting search results to site collections. The replacement substitution contentclass:sts_web provides further focus by limiting search results to web sites. The replacement substitution site: {original token} limits the search to results that are located on the original token's web site, such as Microsoft.com. The Language replacement substitution restricts the search to the language specified in the original token.

The query suggestion component 104 of an embodiment uses a query suggestion algorithm, tokens of a received query, an indexed data structure, and/or information of the substitution database 110 to provide advanced query suggestions based in part on recognized query input terms and one or more mapped replacement substitutes. As described above, the tokenizer 108 can operate to tokenize an input query string into constituent parts. In one embodiment, the tokenizer 108 can be included and used locally with the client 112. In another embodiment, the tokenizer 108 can be included with server 102 as shown in FIG. 1.

It will be appreciated that different methods of tokenization, regular expression, and other parsing and/or string recognition features can be used based in part on an input language used. For example, portions of a received query can be tokenized by a corresponding word breaker according to the query language. For example, a word breaker algorithm can be implemented that operates to parse query inputs based in part on occurrences of white space, punctuation, and/or other parsing keys. Different word breakers can be used according to the input language and/or preferred result language.

Once the input query string is tokenized, the query suggestion component 104 can evaluate the original tokens to determine if one or more of the original tokens map to one or more replacement substitutions. In one embodiment, the query suggestion component 104 can use a last token associated with a user query as a query lookup using the exemplary substitution list in the Table. If an original token matches a recognized query term, the query suggestion component 104 can provide an advanced query suggestion by replacing the corresponding token with a replacement substitution or substitutions. In an alternate embodiment, the query suggestion component 104 can operate without a word breaking component when the query suggestions use a pattern matching algorithm such as a regular expression that does not rely on the input string being broken into segments prior to query suggestion. Alternatively, the word breaking can also be part of the regular expression when the regular expression includes punctuation and/or whitespace or other delimiting characters.

As an example of use of the substitution database 110 by the query suggestion component 104, and assuming that a querying user has entered the string “monthly update doc” into a search interface, the query suggestion component 104 uses original tokens provided by the tokenizer 108 to determine if an original token corresponds with a recognized query term included in the input list (see Table above). If an original token matches or corresponds with a recognized query term, the query suggestion component 104 can operate to replace the recognized query term with one or more replacement substitutions.

For this example, the query suggestion component 104 operates to map the “doc” token to the replacement substitutions “filetype:doc and/or filetype:docx.” Accordingly, the query suggestion component 104 can create an advanced query suggestion based on the original tokens, encoded as “monthly update filetype:doc filetype:docx.” If a user selects the newly formulated query, the search engine 106 can use the replacement substitutions to focus the search. For this case, the search engine 106 uses the terms “filetype:doc and/or filetype:docx” to limit search results to file types that include the .doc and .docx file extensions. It will be appreciated that depending on an underlying search engine implementation, “and” and “or” delimiters may or may not be required in order to achieve a query rewrite or reformulation operation.

In one embodiment, the search server 102 uses a function to return an advanced query suggestion using a number of substitution mappings, but is not so limited.

One exemplary function is as follows:

private QuerySuggestion GetSubstitution(string strQueryText, string
strLastToken, System.Collections.ArrayList tokens, CultureInfo culture)

{

//synchronization for access to application cache, to prevent corruption

by multiple threads

QuerySuggestions.s_CacheLock.AcquireReaderLock(−1);
try
{

//lookup application cache

QuerySuggestionApplicationCache appCache =
QuerySuggestions.GetAppCache(_searchApp.Name);

//lookup substitution index from the application cache based on the

query language
QuerySuggestionLangResPhraseIndex substitutionIndex =
appCache.GetSubstitutionIndex(culture);

if (substitutionIndex != null)
{

//add last token that user typed into the lookup list

QueryTokens replace = new QueryTokens( );

replace.Add(strLastToken, strLastToken);
//find matching substitutions

List<QuerySuggestionLangResPhrase> substitutions =

substitutionIndex.FindMatchingPhrases(replace,

KeywordInclusion.AnyKeyword);

//if we found the substitution, and the user has typed more than just

the substituted keyword

if(substitutions != null && substitutions.Count > 0 &&

strQueryText.Length > strLastToken.Length + 1)

{

//only first substitution applies

QuerySuggestionLangResPhrase substitution = substitutions[0];

//double check to ensure replacement of the correct token and no

parsing error (case insensitive)

string strSubstitution = “ ” + strLastToken;

if (String.Compare(strQueryText, strQueryText.Length −

strLastToken.Length − 1,

strSubstitution, 0,

strLastToken.Length,StringComparison.OrdinalIgnoreCase) == 0)

{

//construct advanced query suggestion by replacing the

substitution with the mapping, trim redundant spaces.
string strSuggestedQuery = strQueryText.Substring(0, strQueryText.Length −
strLastToken.Length − 1).TrimEnd( ) +

“ ” + substitution.Mapping;

//construct the advanced query suggestion object based on the

new suggested query portion and original token(s)
QuerySuggestion qs = new QuerySuggestion(strSuggestedQuery, tokens,
tokens.Count + 1,

string.Empty, string.Empty,

QuerySuggestion.MaxQueryCount, tokens.Count + 1);

//disable capitalization on the mappings
qs.NoCapitalization = true;
//add mapping token

qs.AddToken(substitution.Mapping);
return qs;

}

}

}

}
{

QuerySuggestions.s_CacheLock.ReleaseReaderLock( );

}
return null;

}

The functionality described herein can be used by or part of an operating system (OS), file system, web-based system, or other searching system, but is not so limited. The functionality can also be provided as an added component or feature and used by a host system or other application. In one embodiment, the system 100 can be communicatively coupled to a file system, virtual web, network, and/or other information sources as part of providing searching features. An exemplary computing system that provides query suggestion and searching features includes suitable programming means for operating in accordance with a method of providing suggestions and/or search results.

Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is useable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

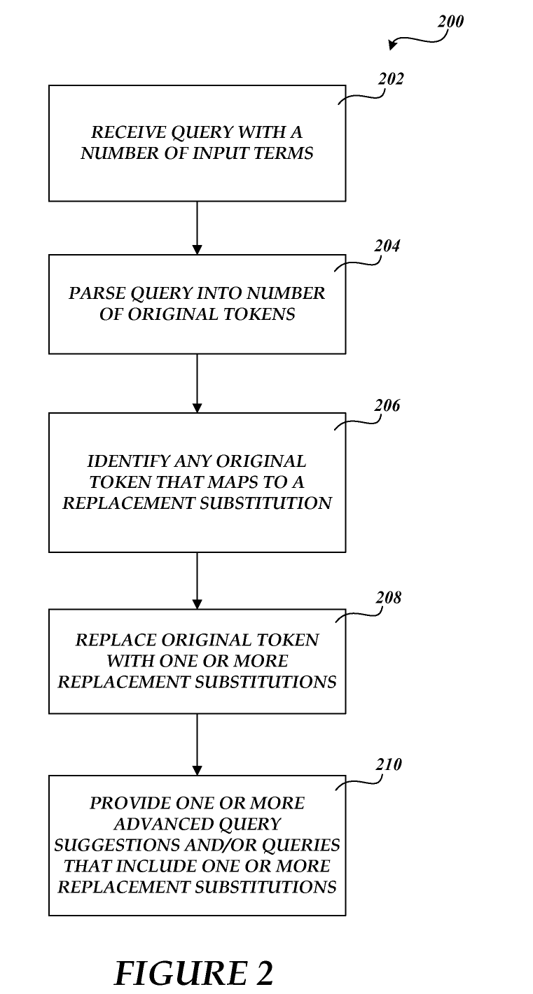

FIG. 2 is a flow diagram illustrating an exemplary process 200 of providing advanced query features, but is not so limited. In an embodiment, the process 200 includes functionality to provide one or more advanced query suggestions including the use of an advanced query syntax to formulate replacement substitutions for recognized tokens associated with a received query. While a certain number and order of operations is described for the exemplary flow of FIG. 2, it will be appreciated that other numbers and/or orders can be used according to desired implementations.

At 202, the process 200 receives a number of input terms associated with a user query. For example, the process 200 can use a web server to receive user input strings submitted using a web-based searching interface. At 204, the process 200 operates to parse or tokenize the input terms into a number of original tokens. For example, the process 200 can use a word breaker application to parse an input string into identifiable tokens which can be used in part to identify substitution mappings to one or more replacement substitutions. In other embodiments, the process 200 at 204 operates to use compiled regular expressions as finite transducers in part to tokenize a query input. In one embodiment, the process 300 can use other language transducers or parsers on a received query.

At 206, the process 200 operates to identify any original token that maps to a replacement substitution. For example, the process 200 at 206 can use a substitution index that includes a number of substitution mappings to determine if an original token corresponds with a replaceable item or items mapped to one or more replacement substitutions. At 208, the process 200 operates to replace an original token with one or more replacement substitutions. For example, the process 200 at 208 can operate to replace an original token with a property name-value pair that can be used to provide further focus as part of a searching operation. In one embodiment, the process 200 at 208 operates to only replace the first recognized original token having a replacement substitution mapping, while not replacing other subsequently identified replaceable items.

At 210, the process 200 operates to provide one or more advanced query suggestions and/or automated queries that include one or more replacement substitutions encoded with an advanced query syntax. In one embodiment, the process 200 includes provision of advanced query suggestions for display along with or adjacent to original query inputs. For example, as part of a web service call, a searching client can operate to display advanced query suggestions including advanced query syntax to a searching user as the user inputs query strings into a searching interface. As described above, advanced query suggestions can be selected by a querying user to provide further focus to a searching operation. In certain embodiments, advanced query suggestion data structures, including corresponding replacement substitution mappings and other information, can be stored locally and/or remotely for further use and/or analysis. For example, a searching system can operate to track and store selected and/or passed over suggestions to determine whether to delete or further enhance certain replacement substitutes and/or mappings.

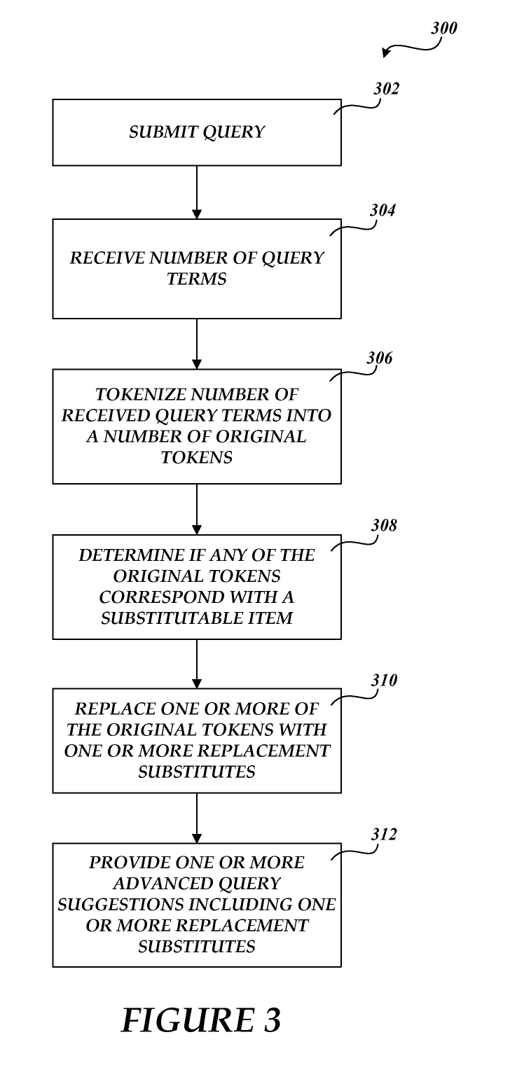

FIG. 3 is a flow diagram illustrating an exemplary process 300 of providing advanced query features using an advanced query syntax. The process 300 of an embodiment includes functionality to provide one or more replacement substitutions included as part of an advanced query suggestion based in part on original tokens of a user query. While a certain number and order of operations is described for the exemplary flow of FIG. 3, it will be appreciated that other numbers and/or orders can be used according to desired implementations.

At 302, the process 300 of an embodiment operates as part of a client server architecture, wherein a client can operate to detect and submit query input strings that include a number of query terms, but is not so limited. For example, a user using a web-based searching interface begins typing a string “monthly update present” which is submitted as part of a web service call to a searching server. At 304, the process 300 uses a server to receive the number of query terms. At 306, the process 300 uses the server to tokenize the number of received query terms into a number of original tokens. For example, the server can use a parsing application to parse input strings into one or more identifiable tokens. In one embodiment, the server can simultaneously receive and tokenize portions of an input string or strings.

At 308, the process 300 of an embodiment uses a server and substitution database to determine if any of the number of original tokens correspond with, map to, or are otherwise equivalent to a substitutable item or items contained in a substitution list of the database, but is not so limited. For example, the process 300 can use a regular expression or other interpretation analysis to determine if an original token matches an item contained in a list of replaceable input items. At 310, the process 300 uses the server to replace an original token with one or more replacement substitutes having an advanced query syntax. Exemplary replacement substitutes encoded with advanced query syntax include, but are not limited to: filetype:doc or filetype:docx for various word processing application related search terms, filetype:ppt or filetype:pptx for various presentation application related search terms, filetype:xsl or filetype:xslx for various spreadsheet application related search terms, filetype:vsd or filetype:vsdx for various drawing application related search terms, and/or contentclass:sts_site or contentclass:sts_web for various site and web related search terms.

In an embodiment, the process 300 can use the server to only make a single replacement substitution for a particular token of a query input. The process 300 of one embodiment uses a number of replacement mappings to replace recognized query terms that include a first replacement mapping from a document-related search term to one or more advanced syntax document mappings, a second replacement mapping from a spreadsheet-related search term to one or more advanced syntax spreadsheet mappings, a third replacement mapping from a drawing-related search term to one or more advanced syntax drawing mappings, a fourth replacement mapping from a presentation-related search term to one or more advanced syntax presentation mappings, and a fifth replacement mapping from a site-related search term to one or more advanced syntax site mappings.

At 312, the process 300 can use the server to package and provide one or more advanced query suggestions including any replacement substitutions encoded with advanced query syntax along with original tokens that were not replaced at 310 to a searching client. In another embodiment, the process 300 can provide advanced query suggestions with a more generic human readable description in place of the advanced query syntax. In an embodiment, replacement substitutions include mappings from recognized tokens to corresponding substitutes. In one embodiment, name-value pairs encoded in an advanced query syntax can be used as replacement substitutions that replace one or more original tokens of a received query input.

It will be appreciated that improvements in processing and networking features can assist in providing a real-time query input and suggestion process to correspond with a user's intended search target. The process 300 of an embodiment can operate to auto-complete replacement substitutions by predicting a replaceable item of a search string. The process 300 of an embodiment can also operate to automatically execute a rewritten query without any user input other than the original query. Aspects of the process 300 can be distributed to and among other components of a computing architecture, and the client server examples and embodiments are not intended to limit features described herein.

FIG. 4 depicts an exemplary search interface 400 that can be used by a searching user to locate relevant information. The search interface 400 depends in part on a search engine and/or a query rewriting algorithm to provide one or more advanced query features and/or relevant search results. For example, the search interface 400 can be provided using a browser application to interact with one or more web-based information sources, such as one or more web and search servers.

As shown in FIG. 4, the search interface 400 includes a search box or window 402 that a user can use to input query terms. For this example, a querying user has entered the terms “monthly update document” in the search window 402. A query suggestion component has operated to populate a suggestion box or window 404 based in part on substitution mappings for the recognized term “document.” As shown, the query suggestion component has populated the suggestion window 404 with three advanced query suggestions. Each suggestion has been encoded using the original query terms “monthly” and “update” along with replacement substitutions having an advanced query syntax, namely “filetype:doc,” “filetype:docx,” and “filetype:doc filetype:docx,” respectively. While, for this example, three suggestions are provided, it will be appreciated that more or fewer suggestions may be provided and/or shown. For example, depending in part on the search settings for a particular search interface, a suggestion component may just provide the filetype:doc filetype:docx replacement substitution for consumption by a querying user. While one exemplary search interface is shown, it will be appreciated that other interface constructs can be implemented.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

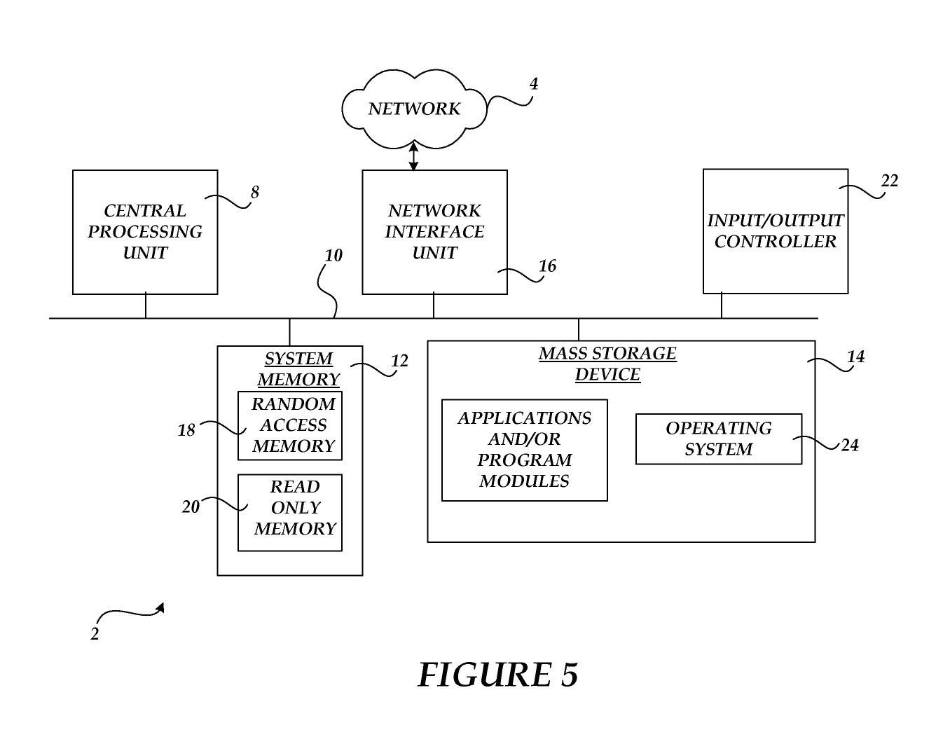

Referring now to FIG. 5, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 5, an illustrative operating environment for embodiments of the invention will be described. As shown in FIG. 5, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
receiving a query including one or more search terms;
recognizing one or more search terms of the query as a recognized query term; and
automatically replacing the one or more recognized query terms with a replacement substitution to form a replacement query wherein the replacement substitution includes an advanced query syntax.

2. The method of claim 1, further comprising automatically executing the replacement query; and
generating a list of results that satisfy the replacement query.

3. The method of claim 1, further comprising using a substitution dictionary having one or more recognized query terms associated with one or more replacement substitutions.

4. The method of claim 3, wherein the recognized query terms are compared to query terms using a case-insensitive compare to determine whether a query term is a recognized query term.

5. The method of claim 3, wherein the recognized query terms are regular expressions that are executed on the query string to detect a recognized query term.

6. The method of claim 1, further comprising presenting one or more replacement queries that include the advanced query syntax, wherein the advanced query syntax indicates an intent to search one or more of a word processing data file, spreadsheet data file , drawing data file, and presentation application file.

7. The method of claim 1, further comprising presenting one or more replacement queries that include the advanced query syntax, wherein the advanced query syntax corresponds with one or more corresponding search terms input into a search interface and define replacement mappings that include a first replacement mapping from a document-related search term to one or more advanced syntax document mappings, a second replacement mapping from a spreadsheet-related search term to one or more advanced syntax spreadsheet mappings, a third replacement mapping from a drawing-related search term to one or more advanced syntax drawing mappings, a fourth replacement mapping from a presentation related search term to one or more advanced syntax presentation mappings, and a fifth replacement mapping from a site-related search term to one or more advanced syntax site mappings.

8. The method of claim 1, further comprising parsing a received query input using a natural language processor to detect a recognized query term.

9. The method of claim 1, further comprising using a last input query token of a received query input when determining whether to replace an input query term with a replacement substitution encoded with the advanced query syntax.

10. The method of claim 1, wherein the replacement substitution includes a portion or all of the recognized query term.

11. The method of claim 1, further comprising detecting that a user is searching for a particular file type and searching for the particular file type using the advanced query syntax.

12. A system comprising:
a server that includes a query suggestion algorithm and other functionality to:
tokenize an input query into one or more original tokens;
recognize the one or more original tokens as one or more recognized items for replacement;
replace the one or more recognized items with one or more target substitutions, wherein each target substitution includes an advanced query syntax; and
provide one or more advanced query suggestions that include the one or more target substitutions and the advanced query syntax; and
memory to store substitution mappings and other information.

13. The system of claim 12, further comprising a user interface to display the one or more advanced query suggestions as part of a computer-implemented search interface.

14. The system of claim 12, wherein the server uses a substitution dictionary that includes the substitution mappings from identified tokens to corresponding target substitutions.

15. The system of claim 12, further comprising a searching client that issues search requests and displays search results including one or more advanced query suggestions.

16. The system of claim 12, wherein the server rewrites each user query according to different substitution index based on a particular input language.

17. A method comprising:
receiving a query string input;
rewriting the query string based in part on inferring of context from the input to provide a reformulated query string including using mappings of one or more query substitutions encoded with an advanced query syntax; and
using the reformulated query string as part of a search operation.

18. The method of claim 17, further comprising displaying a query suggestion that includes the reformulated query string and the advanced query syntax, wherein replacement mappings are used in part to reformulate the query that include a first replacement mapping from a first type of recognized search term to one or more of a first type of advanced syntax mappings, a second replacement mapping from a second type of recognized search term to one or more of a second type of advanced syntax mappings, a third replacement mapping from a third type of recognized search term to one or more of a third type of advanced syntax mappings, a fourth replacement mapping from a fourth type of recognized search term to one or more of a fourth type of advanced syntax mappings, and a fifth replacement mapping from a fifth type of recognized search term to one or more of a fifth type of advanced syntax mappings.

19. The method of claim 17, further comprising parsing the input into constituent tokens and replacing one or more of the constituent tokens with one or more target substitutions, wherein each target substitution is encoded with the advanced query syntax to add further focus to the query string input.

20. The method of claim 19, associating the one or more target substitutions with a substitution dictionary and using a substitution index based in part on a query language and a regular expression algorithm when reformulating the query string.
